(19) United States
(12) Patent Application Publication
(10) Pub. No.: US 2015/0143290 A1
(43) Pub. Date: May 21, 2015

(54) COMMUNICATION SESSION INDEXING

(71) Applicant: International Business Machines Corporation, Armonk, NY (US)

(72) Inventors: Tamer E. Abuelsaad, Somers, NY (US); John Elbert Moore, JR., Indianapolis, IN (US); Rajeshkumar N. Singi, Marietta, GA (US); Robert Richard Wentworth, Austin, TX (US)

(73) Assignee: International Business Machines Corporation, Armonk, NY (US)

(21) Appl. No.: 14/080,824

(22) Filed: Nov. 15, 2013

(51) Int. Cl. G06F 3/0482

(52) U.S. Cl. CPC G06F 3/0482
USPC 715/810

(57) ABSTRACT

A method includes: displaying information from at least one communication session on a user's device; providing at least one interface on the user's device to select at least one portion of the displayed information from the at least one communication session; associating the at least one portion of the at least one communication session with an indexing feature; and presenting the indexing feature on the user's device.

### BACKGROUND

The present invention relates to communication session indexing, and more specifically, to saving a selected section from a communication session.

### SUMMARY

According to one aspect of the present invention, a method includes: displaying information from at least one communication session on a user's device; providing at least one interface on the user's device to select at least one portion of the displayed information from the at least one communication session; associating the at least one portion of the at least one communication session with an indexing feature; and presenting the indexing feature on the user's device.

According to another aspect of the present invention, a computer system includes: one or more processors, one or more computer-readable memories and one or more computer-readable, tangible storage devices; a display module operatively coupled to at least one of the one or more storage devices for execution by at least one of the one or more processors via at least one of the one or more memories, configured to display information from at least one communication session on a user's device; an interface operatively coupled to at least one of the one or more storage devices for execution by at least one of the one or more processors via at least one of the one or more memories, configured to select at least one portion of the displayed information from the at least one communication session; an association module operatively coupled to at least one of the one or more storage devices for execution by at least one of the one or more processors via at least one of the one or more memories, configured to associate the at least one portion of the at least one communication session with an indexing feature; and; the display module operatively coupled to at least one of the one or more storage devices for execution by at least one of the one or more processors via at least one of the one or more memories, is further configured to present the indexing feature on the user's device.

According to yet another aspect of the present invention, a computer program product includes: one or more computer-readable, tangible storage medium; program instructions, stored on at least one of the one or more storage medium, to display information from at least one communication session on a user's device; program instructions, stored on at least one of the one or more storage medium, to provide at least one interface on the user's device to select at least one portion of the displayed information from the at least one communication session; program instructions, stored on at least one of the one or more storage medium, to associate the at least one portion of the at least one communication session with an indexing feature; and program instructions, stored on at least one of the one or more storage medium, to present the indexing feature on the user's device.

### BRIEF DESCRIPTION OF THE SEVERAL VIEWS OF THE DRAWINGS

FIG. 1 shows a flowchart according to an embodiment of the present invention.

FIG. 2 shows an exemplary implementation according to an embodiment of the present invention.

FIGS. 3A and 3B show another exemplary implementations according to an embodiment of the present invention.

FIG. 4 shows still another exemplary implementation according to an embodiment of the present invention.

FIG. 5 shows yet another exemplary implementation according to an embodiment of the present invention.

FIG. 6 illustrates a hardware configuration according to an embodiment of the present invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting. As will be appreciated by one skilled in the art, aspects of the present invention may be embodied as a system, method or computer program product.

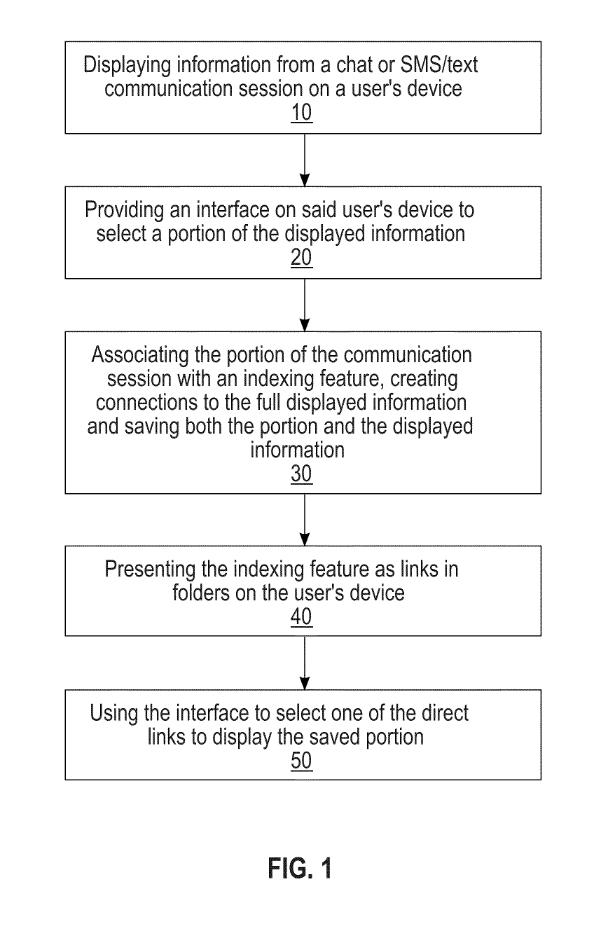

Now referring to FIG. 1, with ever increasing electronic communications sessions such as online chatting and SMS messaging people are sharing more important information than in the past. Electronic message is no longer a means of staying in touch and communicating with friends and loved ones, but has shifted to being used for work, school, banking, etc. Often these messages contain a few important points that are needed for future use. An embodiment of the present invention saves these few important portions of the communication session. A process for saving these important portions from the communication session starts by displaying the entire information from a chat or SMS/text communication session on a user's device (10). The user's device may include personal computers, laptops, tablets and smart phones. An interface is provided on the user's device for selecting a portion of the displayed information (20). The selected portion of the communication session is associated with an indexing feature. The indexing feature is further connected to the full displayed source from the communication session. Once the indexing feature and connections are established the selected portion, and the full displayed information are saved (30). The process then presents the indexing feature as direct links in folders on the user's device (40). When a user wants to display the selected portion the interface is used to select one of the direct links from the folders (50).

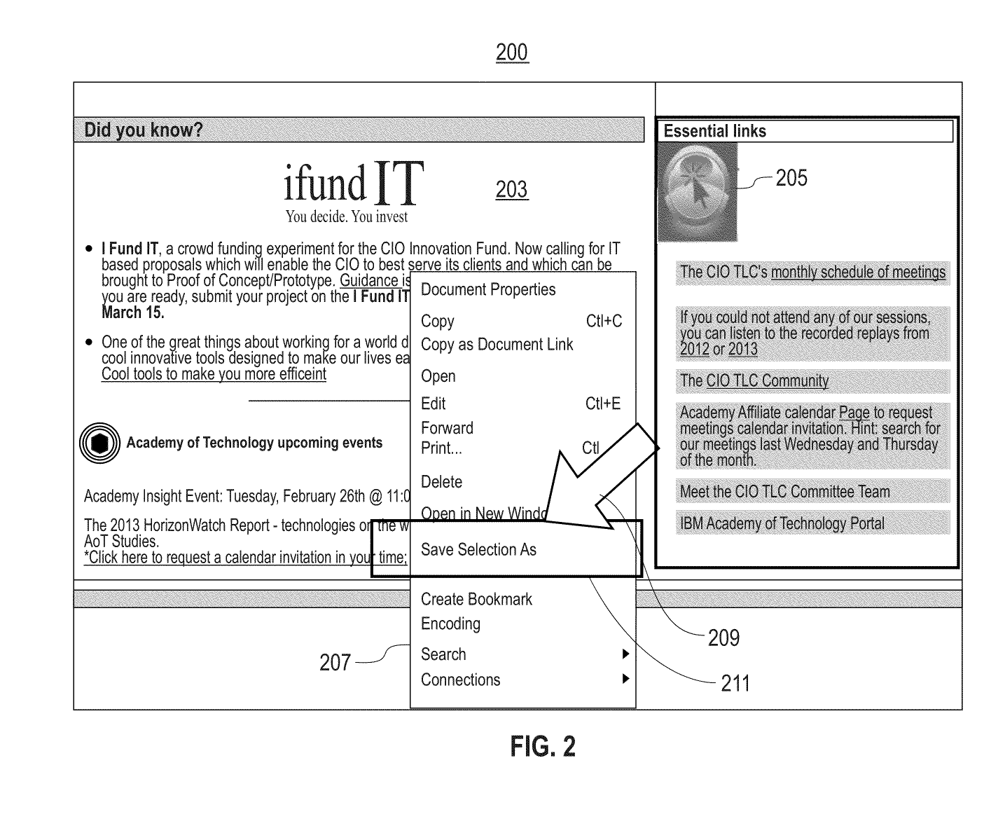

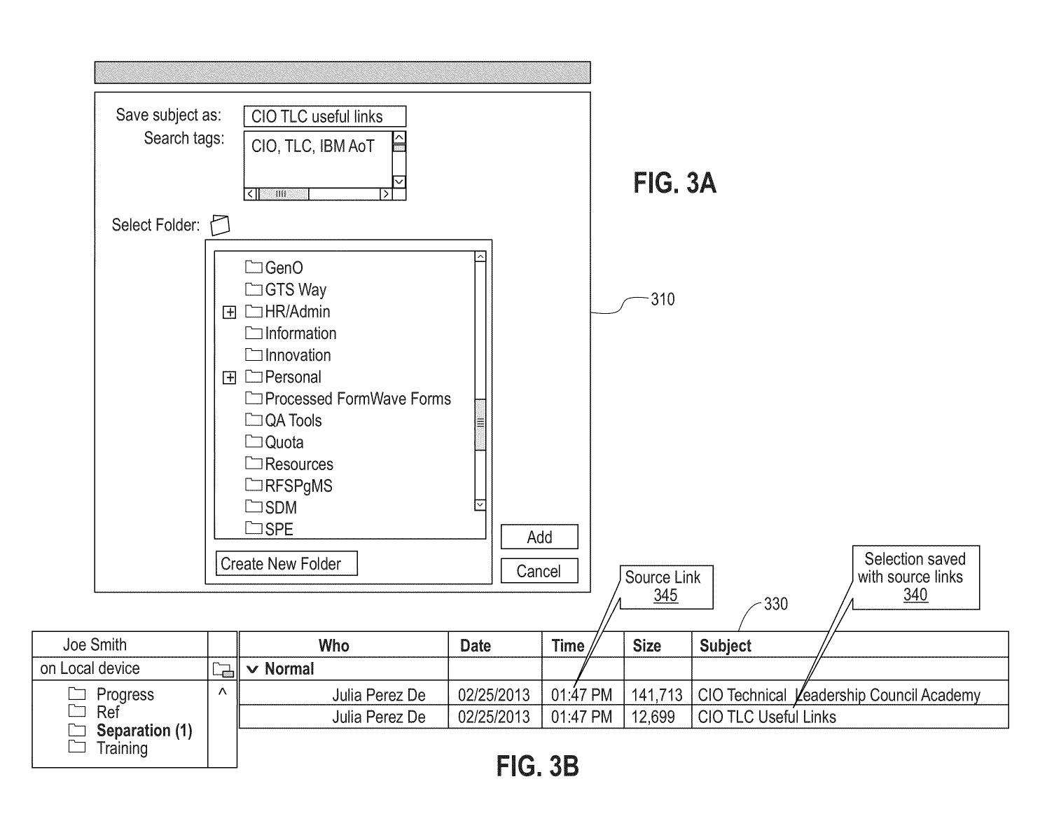

Referring to FIGS. 2, 3A and 3B, an exemplary implementation according to an embodiment of the present invention is depicted. A user's device 200 displays both text and images (203 and 205) from a communication session on the user's device. The user has decided that certain information is important and worth saving. The user selects the image and text from section 205 using interface 209. As is well known, the interface 209 includes a mouse, or some other tool, to control a cursor that includes the capability of selecting text and images. In the present invention, once the selection is completed either a right click (or left) of the interface brings up a menu option window 207. A “Save Selection As” option 211 becomes available. The user uses the interface 209 and selects the “Save Selection As” option 211 which brings up a save in folder window 310. The saved selection is saved as an index feature source link 340. The indexing feature is now saved as a direct link that is now available via a folder window 330 on the user's device. The folder window may a link 345 to the original source from the communication session that was created by establishing a connection between the saved portion and the original source. Thus the folder window 330 can include both links (340, 345) from the communication session. It should be noted that that the saved portion link 340 further includes an embedded link back to the original source when link 340 is opened.

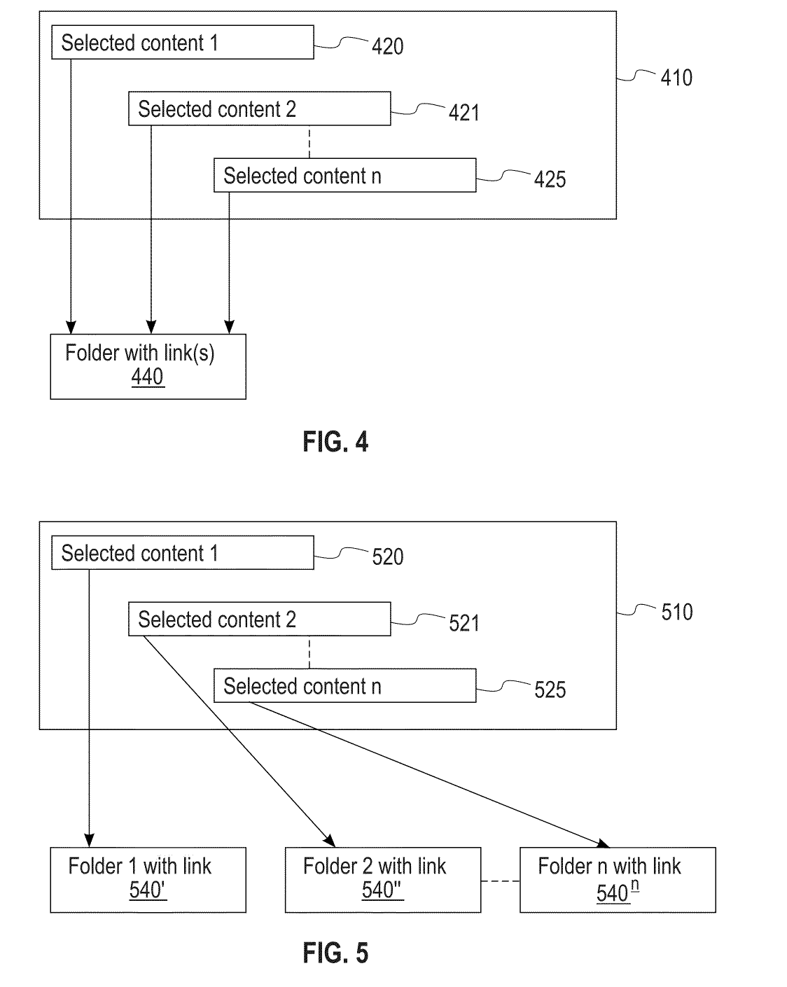

Referring to FIG. 4, another embodiment according to the present invention allows for saving multiple selected portions from a communication session. The display 410 includes selected content (420, 421 through 425) from a chat or SMS/text communication session on the user's device the user wishes to save. Using the process as described with reference to the previous figures, each selected content (420, 421 through 425) can be saved in single folder 440. The saved selections with the index feature source link is now available via the folder 440. Again, the folder may contain links to the original source from the communication session as well as the links for just the saved portion from the communication session. It should be noted that that the saved portion link further includes an embedded link back to the original source when the saved portion links are opened.

Referring to FIG. 5, another embodiment according to the present invention allows for saving multiple selected portions from a communication session. The display 510 includes selected content (520, 521 through 525) from a chat or SMS/text communication session on the user's device the user wishes to save. Using the process as described with reference to the previous figures, each selected content (520, 521 through 525) can be saved in multiple corresponding folders (540′, 540″ through 540ⁿ). The saved selections with the index feature source link is now available via the multiple corresponding folders (540′, 540″ through 540ⁿ). Again, the folder may contain links to the original source from the communication session as well as the links for just the saved portion from the communication session. It should be noted that the saved portion link further includes an embedded link back to the original source when the saved portion links are opened.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

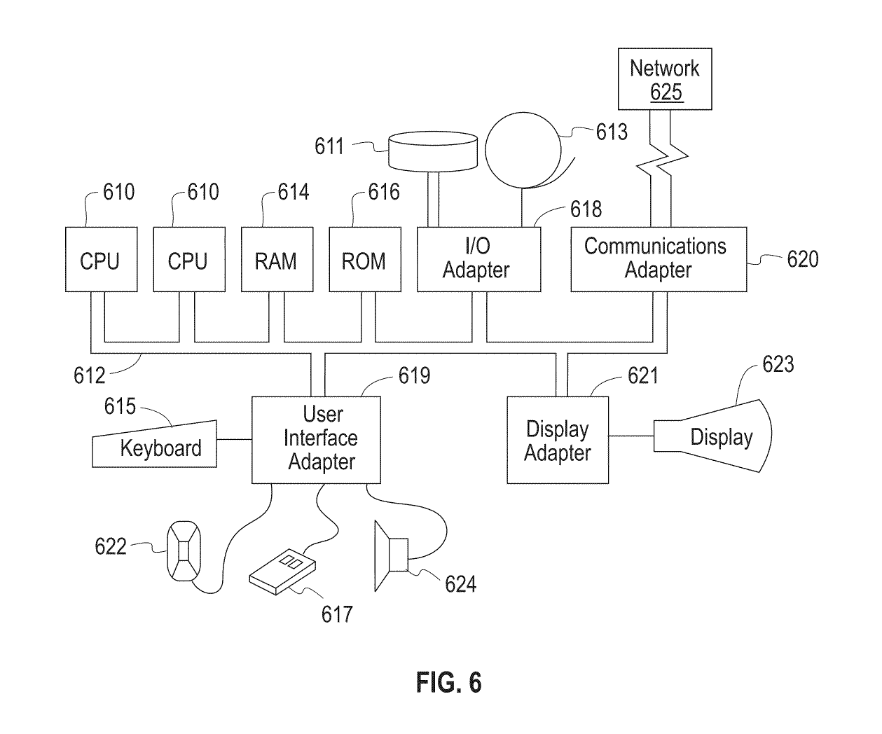

Referring now to FIG. 6, this schematic drawing illustrates a hardware configuration of an information handling/computer system in accordance with the embodiments of the invention. The system comprises at least one processor or central processing unit (CPU) 610. The CPUs 610 are interconnected via system bus 612 to various devices such as a random access memory (RAM) 614, read-only memory (ROM) 616, and an input/output (I/O) adapter 618. The I/O adapter 618 can connect to peripheral devices, such as disk units 611 and tape drives 613, or other program storage devices that are readable by the system. The system can read the inventive instructions on the program storage devices and follow these instructions to execute the methodology of the embodiments of the invention. The system further includes a user interface adapter 619 that connects a keyboard 615, mouse 617, speaker 624, microphone 622, and/or other user interface devices such as a touch screen device (not shown) to the bus 612 to gather user input. Additionally, a communication adapter 620 connects the bus 612 to a data processing network 625, and a display adapter 621 connects the bus 612 to a display device 623 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
displaying information from at least one communication session on a user's device;
providing at least one interface on said user's device to select at least one portion of said displayed information from the at least one communication session;
associating said at least one portion of said at least one communication session with an indexing feature; and
presenting said indexing feature on said user's device.

2. The method according to claim 1, wherein said indexing feature creates a link between said at least one portion and said displayed information.

3. The method according to claim 1, wherein said presenting of said indexing feature to said user's device is done as direct links.

4. The method according to claim 3, wherein said direct links are saved in a local folder on said user's device.

5. The method according to claim 3, wherein said direct links are saved in multiple folders on said user's device.

6. The method according to claim 3, further comprising using said at least one interface to select at least one of said direct links to display said at least one portion.

7. The method according to claim 3, wherein said direct links are saved in multiple folders on said user's device.

8. The method according to claim 1, wherein said communication session is a live chat session.

9. The method according to claim 1, wherein said communication session is a SMS session.

10. A computer system comprising:
one or more processors, one or more computer-readable memories and one or more computer-readable, tangible storage devices;
a display module operatively coupled to at least one of the one or more storage devices for execution by at least one of the one or more processors via at least one of the one or more memories, configured to display information from at least one communication session on a user's device;
an interface operatively coupled to at least one of the one or more storage devices for execution by at least one of the one or more processors via at least one of the one or more memories, configured to select at least one portion of said displayed information from the at least one communication session;
an association module operatively coupled to at least one of the one or more storage devices for execution by at least one of the one or more processors via at least one of the one or more memories, configured to associate said at least one portion of said at least one communication session with an indexing feature; and;
the display module operatively coupled to at least one of the one or more storage devices for execution by at least one of the one or more processors via at least one of the one or more memories, is further configured to present said indexing feature on said user's device.

11. The system according to claim 10, wherein said indexing feature creates a link between said at least one portion and said displayed information.

12. The system according to claim 10, wherein said presenting of said indexing feature to said user's device is done as direct links.

13. The system according to claim 12, wherein said direct links are saved in a local folder on said user's device.

14. The system according to claim 12, wherein said direct links are saved in multiple folders on said user's device.

15. The system according to claim 12, further comprising the display module coupled to at least one of the one or more storage devices for execution by at least one of the one or more processors via at least one of the one or more memories, is further configured to display said at least one portion after at least one of said direct links is selected.

16. A computer program product comprising:
one or more computer-readable, tangible storage medium;
program instructions, stored on at least one of the one or more storage medium, to display information from at least one communication session on a user's device;
program instructions, stored on at least one of the one or more storage medium, to provide at least one interface on said user's device to select at least one portion of said displayed information from the at least one communication session;
program instructions, stored on at least one of the one or more storage medium, to associate said at least one portion of said at least one communication session with an indexing feature; and
program instructions, stored on at least one of the one or more storage medium, to present said indexing feature on said user's device.

17. The computer program product according to claim 16, wherein said indexing feature creates a link between said at least one portion and said displayed information.

18. The computer program product according to claim 16, wherein said presenting of said indexing feature to said user's device is done as direct links.

19. The computer program product according to claim 18, wherein said direct links are saved in a local folder on said user's device.

20. The computer program product according to claim 18, further includes program instructions, stored on at least one of the one or more storage medium, to display said at least one portion after at least one of said direct links is selected.
